(19) United States
(12) Patent Application Publication
(10) Pub. No.: US 2005/0140850 A1
(43) Pub. Date: Jun. 30, 2005

(54) Edge backlight module and liquid crystal display utilizing the same

(76) Inventors: Sheng-Lun Su, Changjhih Township (TW); Ping-Yi Hsieh, Hemei Township (TW); Ju-Chun Lai, Waipu Township (TW); Ming-Hung Chen, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/892,412

(22) Filed: Jul. 15, 2004

(30) Foreign Application Priority Data
Dec. 29, 2003 (TW) 92137321

(51) Int. Cl. G02F 1/1335

(52) U.S. Cl. 349/65

(57) ABSTRACT

An edge backlight module and liquid crystal display utilizing the same. The edge backlight module comprises a light source module, a light guide plate, and a reflective back plate. The reflective back plate has a reflective surface and a wraparound end facing the reflective surface. The light guide plate is disposed at the reflective surface of the reflective back plate, and an end of the light guide plate is connected to the wraparound end forming a cavity therebetween. The light source module is disposed in the cavity. A reflective layer can be formed by die casting or coated on the reflective surface of the reflective back plate.

### BACKGROUND

1. Field of the Invention

The present invention relates to an edge backlight module and a liquid crystal display utilizing the same.

2. Description of the Related Art

Generally, an LCD comprises a liquid crystal panel and a backlight module. The liquid crystal panel is the display of the LCD. Since the liquid crystal panel does not emit light, a light source providing sufficient brightness and uniform distribution is required to properly display images. A backlight module serves as the light source for the LCD.

Generally, backlight modules can be categorized as direct and edge structures. In direct backlight modules the light source is disposed directly in the cavity of the backlight module, thus occupying a relatively larger volume thereof. In edge backlight modules (also referred to as side-light modules), the light source is disposed on a side of the backlight module to reduce volume thereof, and a light guide plate guides the light toward the liquid crystal panel.

FIG. 1 is an exploded view showing a conventional edge backlight module. In FIG. 1, the conventional edge backlight module 1 comprises a frame 11, light dispersing films 12, a light guide plate 13, a reflective plate 14, a back plate 15, and two light source modules 16 disposed at each side of the edge backlight module 1 respectively. Each light source module 16 comprises at least one lamp as the light source 161, a light source reflector 162, a rubber bushing 163 to fix the light source 161, cables 164 and connectors 165 for connecting and driving the light source 161. During assembly, the reflective plate 14, the light guide plate 13, the light dispersing films 12 and the frame 11 are sequentially attached to the back plate 15, and light source modules 16 are disposed on each side of the edge backlight module 1 in the clearance between the light guide plate 13 and the back plate 15.

The light source module 16 shown in FIG. 1 is described in detail with reference to a cross-section thereof shown in FIG. 2. In FIG. 2, the reflective plate 14 backs only a portion of the light source module 16. Thus, the light source reflector 162 enclosing the light source 161 is required to prevent light leakage. The light source reflector 162 is a C-shaped structure connected to the end portions of the light guide plate 13 and the reflective plate 14. Thus, a cavity 17 is formed between the light source reflector 162, the reflective plate 14 and the light guide plate 13. Light emitted from the light source 161 is reflected in the cavity 17 to the light guide plate 13 without leaking out.

The light source reflector 162 is a separate element, however, and is difficult to accurately position during assembly. Further, additional reflective materials are required in manufacturing the light source reflector 162, increasing material consumption.

### SUMMARY OF THE INVENTION

Accordingly, an object of the present invention is to provide an edge backlight module with fewer elements in the light source module, thus simplifying positioning during assembly.

The present invention discloses an edge backlight module. The edge backlight module comprises a light source module, a light guide plate, and a reflective back plate. The reflective back plate has a reflective surface and at least one wraparound end. The light guide plate is disposed at the reflective surface of the reflective back plate, and an end of the light guide plate is connected to the wraparound end forming a cavity therebetween. The light source module is disposed in the cavity. A reflective layer can be fabricated by die casting or coated on the reflective surface of the reflective back plate.

Further, the present invention discloses a liquid crystal display. The LCD comprises a liquid crystal panel and the above-mentioned edge backlight module, with the reflective surface of the reflective back plate facing the liquid crystal panel. Further, the LCD comprises a bezel at the side of the liquid crystal panel enclosing the edge backlight module.

According to the present invention, the reflective surface of the reflective back plate extends to the light source module, and the wraparound end of the reflective back plate encloses the end of the light guide plate forming a cavity for the light source module. Thus simplifying the structure of the light source module, and enabling accurate positioning of the elements during assembly.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an exploded view of a conventional edge backlight module 1;

FIG. 2 is a cross-section of a portion of the conventional edge backlight module 1 along line A-A in FIG. 1;

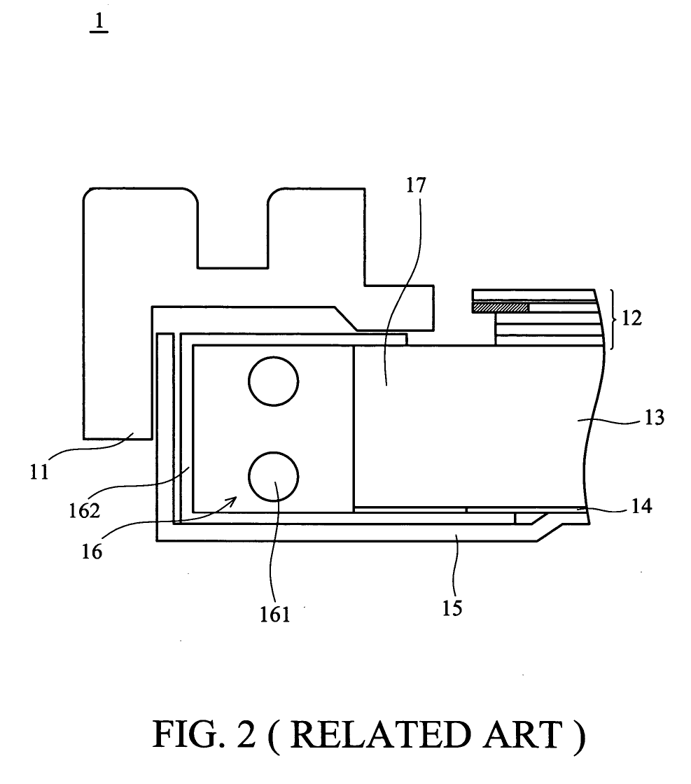

FIG. 3 is an exploded view of the edge backlight module 2 of the present invention; and

FIG. 4 is a cross-section of a portion of the edge backlight module 2 along line B-B in FIG. 3.

### DETAILED DESCRIPTION OF THE INVENTION

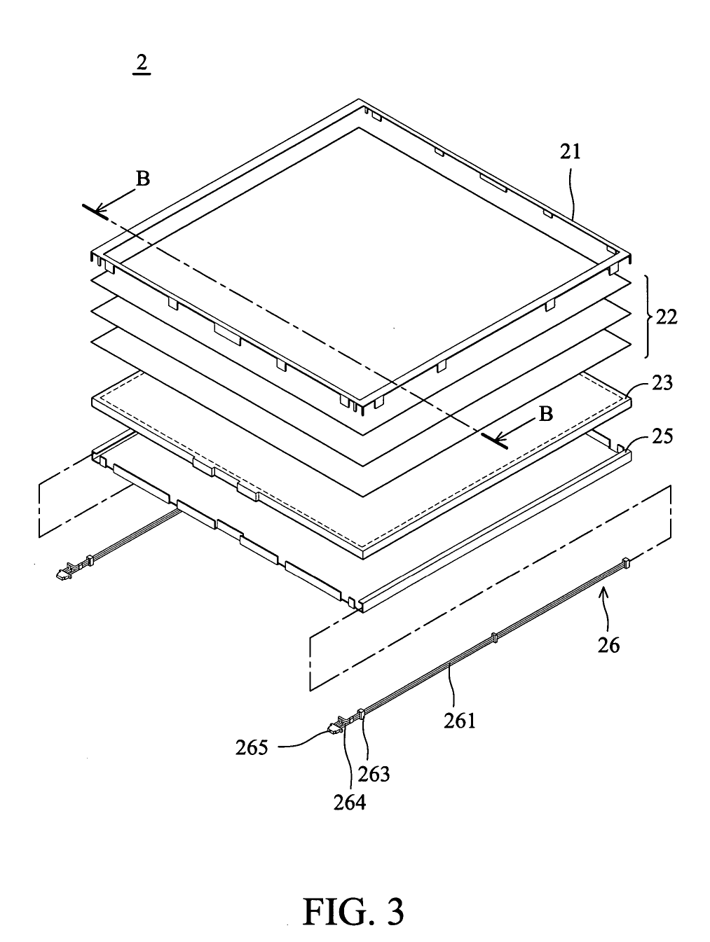

The present invention relates to an edge backlight module. The edge backlight module of the present invention is described hereinafter with reference to FIG. 3.

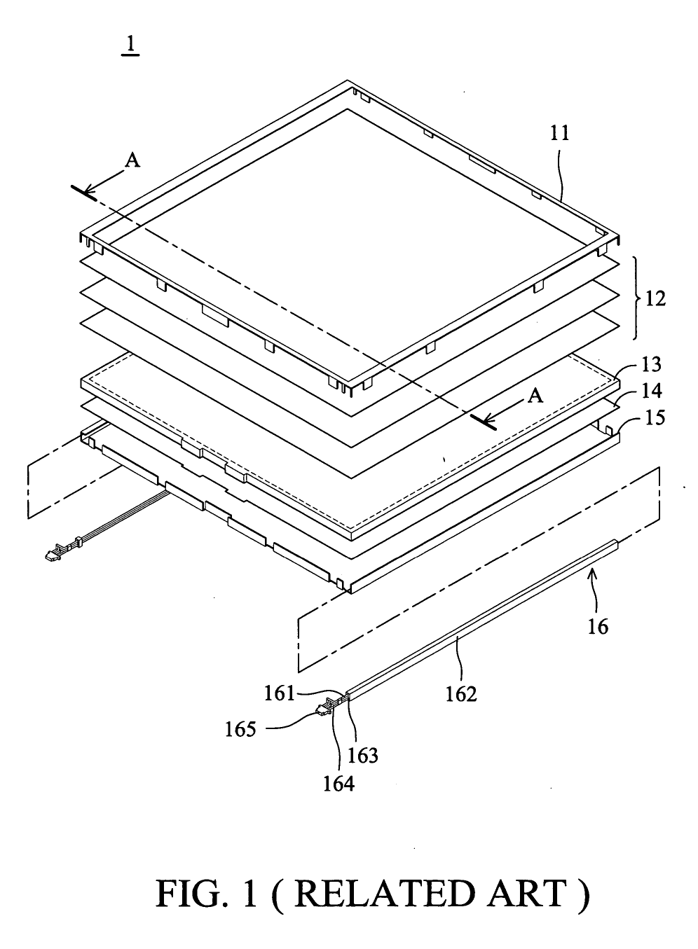

In FIG. 3, the edge backlight module 2 comprises a frame 21, light dispersing films 22, a light guide plate 23, a reflective back plate 25, and two light source modules 26 disposed at each side of the edge backlight module 2. The reflective back plate 25 of the present invention is an individual element rather than the separate reflective plate 14 and back plate 15 as shown in FIG. 1. Each light source module 26 has at least one lamp serving as the light source 261, a rubber bushing 263 to fix the light source 261, and cables 264 and connectors 265 for connecting and driving the light source 261.

During assembly, the light guide plate 23, the light dispersing films 22 and the frame 21 are sequentially attached to the reflective back plate 25, and the light source modules 26 are inserted on each side of the edge backlight module 2 in the cavity 27 between the light guide plate 23 and the reflective back plate 25.

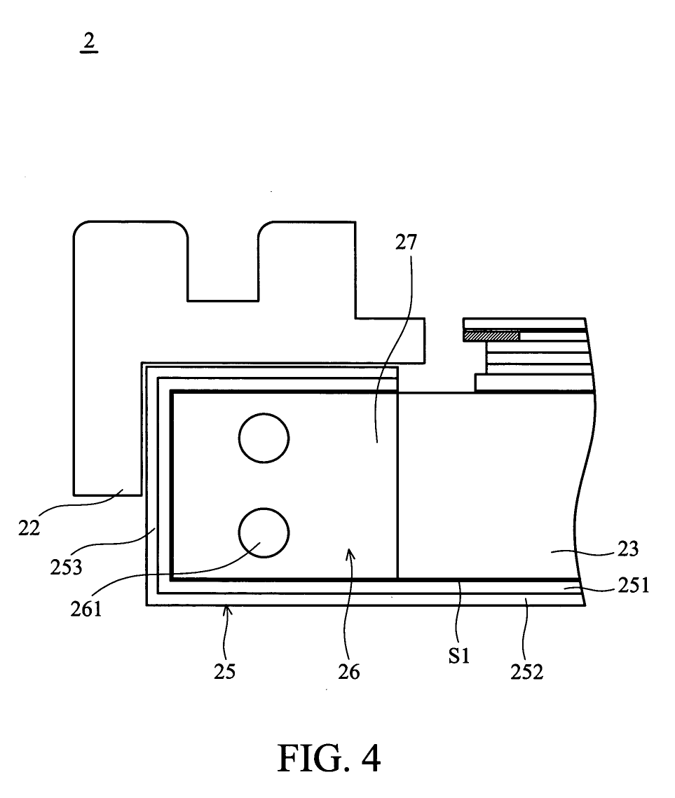

The light source module 26 in FIG. 3 can be described in detail with reference to FIG. 4. In FIG. 4, the reflective back plate 25 comprises a reflective surface S1, and a wraparound end 253 facing the reflective surface S1. The reflective surface S1 can be formed by coating or die casting of reflective materials. Specifically, the reflective back plate 25 can be obtained by coating or die-casting a reflective layer 251 on a flat plate 252 to form the reflective surface S1, and punching or pressing the flat plate 252 to form the wraparound end 253.

The light guide plate 23 is disposed and attached to the reflective surface S1 of the reflective back plate 25, and an end of the light guide plate 23 is connected to the wraparound end 253, such that a cavity 27 is formed between the end of the light guide plate 23 and the wraparound end 253. Thus, the light source module 26 is inserted in the cavity 27 without requiring the light source reflector 162 shown in FIG. 1.

Since the reflective surface S1 is extended to the inner surface of the wraparound end 253, light emitted from the light source 261 is reflected in the cavity 27 to the light guide plate 23 without leaking out.

The edge backlight module 2 in the embodiment can be applied in a liquid crystal display or any other display requiring a backlight module. Specifically, a liquid crystal panel is provided, and the edge backlight module 2 is disposed at a side of the liquid crystal panel with the reflective surface S1 facing the liquid crystal panel. A bezel can be further provided to enclose the edge backlight module 2.

According to the present invention, the reflective back plate 25 is extended to form the wraparound end 253, which encloses the end of the light guide plate 23 to form the cavity 27 enclosing the light source module 27. Thus simplifying the structure of the light source module 27 and enabling accurate positioning of the elements of the edge backlight module 2 during assembly.

The reflective surface S1 in the embodiment is obtained by coating or die-casting a reflective layer on the reflective back plate 25. The reflective surface S1, however, is not limited to this. Further, the shape and size of the wraparound end 253 are relative to the light source module 27 and are not limited to the disclosed shape and size.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An edge backlight module, comprising:
a reflective back plate having a reflective surface and a wraparound end facing the reflective surface;
a light guide plate disposed at the reflective surface of the reflective back plate, an end of the light guide plate connected to the wraparound end to form a cavity therebetween; and
a light source module disposed in the cavity.

2. The edge backlight module as claimed in claim 1, wherein a reflective layer is formed by die casting on the reflective surface of the reflective back plate.

3. The edge backlight module as claimed in claim 1, wherein a reflective layer is coated on the reflective surface of the reflective back plate.

4. A liquid crystal display, comprising:
a liquid crystal panel; and
an edge backlight module disposed at a side of the liquid crystal panel, comprising:
a reflective back plate having a reflective surface facing the liquid crystal panel and a wraparound end facing the reflective surface;
a light guide plate disposed at the reflective surface of the reflective back plate, an end of the light guide plate connected to the wraparound end to form a cavity therebetween; and
a light source module disposed in the cavity.

5. The liquid crystal display as claimed in claim 4, further comprising a bezel enclosing the edge backlight module.

6. The liquid crystal display as claimed in claim 4, wherein a reflective layer is formed by die casting on the reflective surface of the reflective back plate.

7. The liquid crystal display as claimed in claim 4, wherein a reflective layer is coated on the reflective surface of the reflective back plate.
